(19) United States
(12) Patent Application Publication
(10) Pub. No.: US 2023/0362714 A1
(43) Pub. Date: Nov. 9, 2023

(54) Sending and Receiving a PDU

(71) Applicant: Telefonaktiebolaget LM Ericsson (PUBL), Stockholm (SE)

(72) Inventors: Min Wang, LULEÅ (SE); Jan Christoffersson, LULEÅ (SE); Bikramjit Singh, RAASEPORI (FI); Mårten Ericson, GAMMELSTAD (SE); Majid Gerami, LUND (SE); Stefan Wänstedt, LULEÅ (SE)

(21) Appl. No.: 18/003,367

(22) PCT Filed: Apr. 12, 2021
(86) PCT No.: PCT/EP2021/059393

§ 371 Date: Dec. 27, 2022

(30) Foreign Application Priority Data
Jul. 1, 2020 (WO) PCT/EP2020/068575

(51) Int. Cl. H04W 28/02; H04L 47/43

(52) U.S. Cl. CPC H04W 28/0278; H04L 47/43

(57) ABSTRACT

In an example, a method in a terminal device is disclosed. The method comprises determining a Protocol Data Unit (PDU), wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value. The method also comprises transmitting the PDU to a network node.

### TECHNICAL FELD

Examples of this disclosure relate sending and receiving a Protocol Data Unit (PDU).

### BACKGROUND

Generally, al terms used herein are to be interpreted according to the ordinary meaning in the relevant technical field, unless a different meaning is clearly given and/or is implied from the context in which it is used AI references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit the a step must follow or precede another step. Any feature of any of the embodiments disclosed herein may be applied to any other embodiment, wherever appropriate. Likewise, any advantage of any of the embodiments may apply to any other embodiments, and vice versa Other objectives, features and advantages of the enclosed embodiments will be apparent from the following description.

NR Operation in mm-Wave Bands

Mobile broadband will continue to dive the demands for higher overall traffic capacity and higher achievable end-user data rates in the wireless access network. Several of the expected 6G scenarios require data rates of up to 10 Gbps in local areas. Such demands for very high system capacity and very high end-user date rates can be met by sufficiently dense networks, with distances between access nodes ranging from a few meters in indoor deployments up to roughly 50 m in outdoor deployments, and large transmission bandwidth. The wide transmission bandwidths needed to provide data rates up to 10 Gbps and above can likely only be obtained from spectrum allocations in the millimeter-wave bands, i.e. 30 GHz-300 GHz (Note: for 5G, frequencies starting from 6 GHz are included). High-gain beamforming, typically realized with array antennas, can be used to mitigate the increased pathloss at higher frequencies. We refer to such networks as NR systems in the following.

NR supports a diverse set of use cases and a diverse set of deployment scenarios. The latter includes deployment at both low frequencies (100s of MHz), and very high frequencies (tens of GHz). Two operation frequency ranges are defined in NR Rel-15: FR1 from 410 MHz to 7125 MHz and FR2 from 24.250 GHz to 52.6 GHz. 3GPP RAN is currently (NR Rel-17) studying how to best support NR operation on FR2 frequencies, i.e. from 52.6 GHz to 71 GHz ([Error! Reference source not found.]); the study item which includes the following objectives:
Study of required changes to NR using existing DL/UL NR waveform to support operation between 52.6 GHz and 71 GHz
   Study of applicable numerology including subcarrier spacing, channel BW (including maximum B), and their impact to FR2 physical layer design to support system functionality considering practical RF impairments [RAN1, RAN4].
   Identify potential critical problems to physical signal/channels if any [RAN1].
Study of channel access mechanism, considering potential interference to/from other nodes, assuming beam-based operation, in order to comply with the regulatory requirements applicable to unlicensed spectrum or frequencies between 52.6 GHz and 71 GHz [RAN1].
   Note: It is clarified that potential interference impact if identified, may require interference mitigation solutions as part of channel access mechanism.

NR Frame Structure

NR uses OFDM (Orthogonal Frequency Division Multiplexing) in the downlink (i.e. from a network node, gNB, eNB, or base station, to a user equipment (UE)). The basic NR physical resource over an antenna port can thus be seen as a time-frequency grid as illustrated in FIG. 1, which shows FIG. 1 shows an example of a NR physical resource grid. A resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ∈(0, 1, 2, 3, 4). Δf=15 kHz is the basic (or reference) subcarrier spacing. In the time domain, downlink and uplink transmissions in NR will be organized into equally-sized subframes of 1 ms. A subframe is further divided into multiple slots of equal duration. The slot length for subcarrier spacing Δf=(15×2\hat{ }μ) kHz is ½\hat{ }μms. There is only one slot per subframe for Δf=15 kHz and a slot consists of 14 OFDM symbols.

Downlink transmissions are dynamically scheduled, i.e., in each slot the gNB transmits downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including SSB, CSI-RS, etc.

Uplink data transmissions, carried on Physical Uplink Shared Channel (PUSCH), can also be dynamically scheduled by the gNB by transmitting a DCI. The DCI (which is transmitted in the DL region) always indicates a scheduling time offset so that the PUSCH is transmitted in a slot in the UL region.

Buffer Status Reporting

As described in the 3GPP TS 38.321 [2] clause 5.4.5, the Buffer Status reporting (BSR) procedure is used to provide the serving gNB with information about UL data volume in the MAC entity. In the case of IAB, it is additionally used by an IAB-MT to provide its parent IAB-DU with the information about the amount of the data expected to arrive at the MT of the IAB node from its child node(s) and or UE(s) connected to it. This BSR is referred to as Pre-emptive BSR.

### SUMMARY

One aspect of the present disclosure provides a method in a terminal device. The method comprises determining a Protocol Data Unit (PDU), wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value; and transmitting the PDU to a network node.

Another aspect of the present disclosure provides a method in a network node. The method comprises receiving a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value; and obtaining the current buffer status of the terminal device by modifying the previous buffer status of the terminal device by the buffer status modification value.

Another aspect of the present disclosure provides a method in a terminal device. The method comprises transmitting a predetermined number of Protocol Data Units (PDUs) and/or a predetermined number of data bytes; and transmitting a next PDU comprising at least a sub-PDU to a network node, wherein the sub-PDU includes an indication of a buffer status of the terminal device.

Another aspect of the present disclosure provides a method in a network node. The method comprises receiving a predetermined number of Protocol Data Units (PDUs) and/or a predetermined number of date bytes; and receiving a next PDU comprising at least a sub-PDU from a terminal device, wherein the sub-PDU includes an indication of a buffer status of the terminal device.

Another aspect of the present disclosure provides apparatus in a terminal device, the apparatus comprising a processor and a memory, the memory containing instructions executable by the processor such that the apparatus is operable to determine a Protocol Data Unit (PDU), wherein the PDU comprises at least a sub-PDU, the sub-PDU comprising at least a subheader, the sub-PDU including an indication of a buffer status modification value, wherein a current buffer status of the terminal device comprises a previous buffer status of the terminal device modified by the buffer status modification value; and transmit the PDU to a network node.

Another aspect of the present disclosure provides apparatus in a network node, the apparatus comprising a processor and a memory, the memory containing instructions executable by the processor such that the apparatus is operable to receive a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value; and obtain the current buffer status of the terminal device by modifying the previous buffer status of the terminal device by the buffer status modification value.

Another aspect of the present disclosure provides Apparatus in a terminal device, the apparatus comprising a processor and a memory, the memory containing instructions executable by the processor such that the apparatus is operable to transmit a predetermined number of Protocol Data Units (PDUs) and/or a predetermined number of data bytes; and transmit a next PDU comprising at least a sub-PDU to a network node, wherein the sub-PDU includes an indication of a buffer status of the terminal device.

Another aspect of the present disclosure provides apparatus in a network node, the apparatus comprising a processor and a memory, the memory containing instructions executable by the processor such that the apparatus is operable to receive a predetermined number of Protocol Data Units (PDUs) and/or a predetermined number of data bytes; and receive a next PDU comprising at least a sub-PDU from a terminal device, wherein the sub-PDU includes an indication of a buffer status of the terminal device.

Another aspect of the present disclosure provides apparatus in a terminal device, the apparatus configured to determine a Protocol Data Unit (PDU), wherein the PDU comprises at least a sub-PDU, the sub-PDU comprising at least a subheader, the sub-PDU including an indication of a buffer status modification value, wherein a current buffer status of the terminal device comprises a previous buffer status of the terminal device modified by the buffer status modification value; and transmit the PDU to a network node.

Another aspect of the present disclosure provides apparatus in a network node, the apparatus configured to receive a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value; and obtain the current buffer status if the terminal device by modifying the previous buffer status of the terminal device by the buffer status modification value.

Another aspect of the present disclosure provides apparatus in a terminal device, the apparatus configured to transmit a predetermined number of Protocol Data Units (PDUs) and/or a predetermined number of data bytes; and transmit a next PDU comprising at least a sub-PDU to a network node, wherein the sub-PDU includes an indication of a buffer status of the terminal device.

Another aspect of the present disclosure provides apparatus in a network node, the apparatus configured to receive a predetermined number of Protocol Data Units (PDUs) and/or a predetermined number of data bytes; and receive a next PDU comprising at least a sub-PDU from a terminal device, wherein the sub-PDU includes an indication of a buffer status of the terminal device.

Another aspect of the present disclosure provides a computer program comprising instructions which, when executed on at least one processor, cause the at least one processor to carry out a method according to any of the above aspects.

Another aspect of the present disclosure provides a carrier containing a computer program according to the above computer program, wherein the carrier comprises one of an electronic signal, optical signal, radio signal or computer readable storage medium.

Another aspect of the present disclosure provides a computer program product comprising non transitory computer readable media having stored thereon a computer program according to the above computer program.

Another aspect of the present disclosure provides apparatus including Determining Unit configured to determine a Protocol Data Unit (PDU), wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value, and Transmitting Unit configured to transmit the PDU to a network node.

Another aspect of the present disclosure provides apparatus including Receiving Unit configured to receive a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value, and Obtaining Unit configured to obtain the current buffer status of the terminal device by modifying the previous buffer status of the terminal device by the buffer status modification value.

Another aspect of the present disclosure provides apparatus including First Transmitting Unit configured to transmit a predetermined number of Protocol Data Units (PDUs) and/or a predetermined number of data bytes, and Second Transmitting Unit configured to transmit a next PDU comprising at least a sub-PDU to a network node, wherein the sub-PDU includes an indication of a buffer status of the terminal device.

Another aspect of the present disclosure provides apparatus including First Receiving Unit configured to receive a predetermined number of Protocol Data Units (PDUs) and/or a predetermined number of data bytes, and Second Receiving Unit configured to receive a next PDU comprising at least a sub-PDU from a terminal device, wherein the sub-PDU includes an indication of a buffer status of the terminal device.

Technical effects provided by at least some of these and/or other aspects of the present disclosure may include the ability to transmit buffer status information efficiently, such as for example using a reduced amount of information or number of bits as compared to previous buffer status reporting procedures.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows an example of a NR physical resource grid;

FIG. 2A shows an example of a R/F/LCID/L MAC subheader with 8-bit L field;

FIG. 2B shows an example of a R/F/LCID/L MAC subheader with 16-bit L field;

FIG. 2C shows an example of a R/LCID MAC subheader;

FIG. 3 shows an example of a DL MAC PDU;

FIG. 4 shows an example of an UL MAC PDU;

FIG. 5A shows an example of a Short BSR and Short Truncated BSR MAC CE in 3GPP TS 38.321;

FIG. 5B shows an example of Long BSR, Long Truncated BSR, and Pre-emptive BSR MAC CE in 3GPP TS 38.321;

FIG. 6 shows an overview of UL transmission delay;

FIG. 7 is a flow chart of an example of a method in a terminal device;

FIG. 8 is a flow chart of an example of a method in a network node;

FIG. 9 is a flow chart of an example of a method in a terminal device;

FIG. 10 is a flow chart of an example of a method in a network node;

FIG. 11 shows an example of a wireless network in accordance with some embodiments;

FIG. 12 shows an example of a User Equipment in accordance with some embodiments;

FIG. 13 shows an example of a virtualization environment n accordance with some embodiments;

FIG. 14 shows an example of a telecommunication network connected via an intermediate network to a host computer n accordance with some embodiments;

FIG. 15 shows an example of a host computer communicating via a base station with a user equipment over a partially wireless connection in accordance with some embodiments;

FIG. 16 shows examples of methods implemented in a communication system inducing a host computer, a base station and a user equipment in accordance with some embodiments;

FIG. 17 shows examples of methods implemented in a communication system including a host computer, a base station and a user equipment in accordance with some embodiments;

FIG. 18 shows examples of methods implemented in a communication system including a host computer, a base station and a user equipment in accordance with some embodiments;

FIG. 19 shows examples of methods implemented in a communication system including a host computer, a base station and a user equipment in accordance with some embodiments;

FIG. 20 shows an example of virtualization apparatus in accordance with some embodiments;

FIG. 21 shows another example of virtualization apparatus in accordance with some embodiments;

FIG. 22 shows another example of virtualization apparatus in accordance with some embodiments; and

FIG. 23 shows another example of virtualization apparatus in accordance with some embodiments.

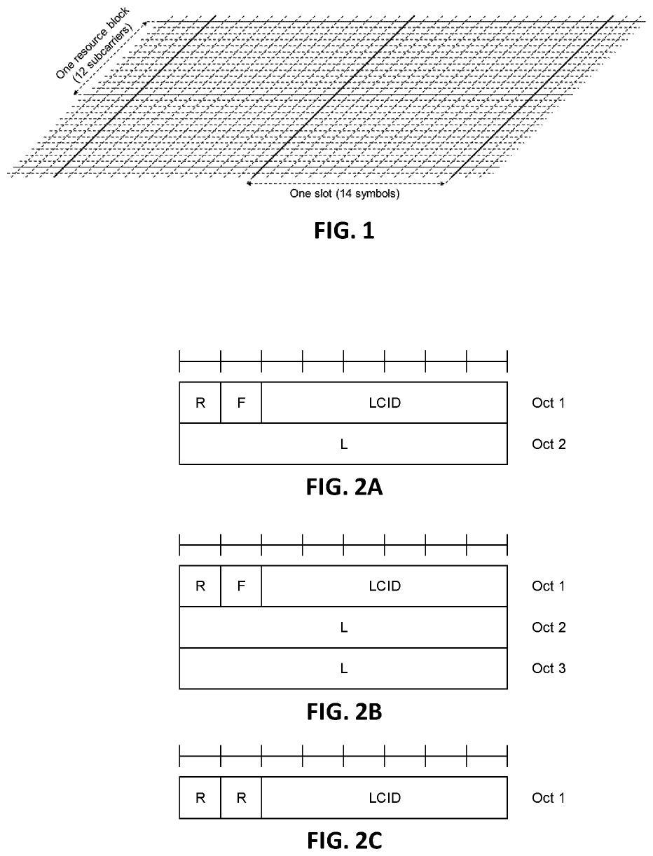

### DETAILED DESCRIPTION

The following sets forth specific details, such as particular embodiments or examples for purposes of explanation and not imitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions the would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

There currently exist certain challenge(s). For example, the current BSR framework is versatile but, in some cases, adds unnecessary overhead. Even a short BSR will need 2 bytes, 1 for the MAC subheader and 1 for BSR. Such overhead results in poor performance in general; in particular, increased UE power consumption ay result. One problem is that the UE needs to construct a new MAC CE exclusively for the BSR transmission. This MAC CE includes a subheader+the BSR data, where the subheader is 1-3 octets long. This creates unnecessary overhead for a small adjustment, especially if there is just a small update of the buffer status report. Also, in cases with small data packets, the BSR overhead may be significant.

Certain aspects of the present disclosure and their embodiments may provide solutions to at least one of these or other challenges. For example, examples of this disclosure may provide functionality that reduces the overhead from BSR in cases where a BSR lite is especially important. Examples may create new fields in the MAC sub-header coupled to the PUSCH data (the MAC SDU), so there is no reason to create the MAC sub-PDU just for a BSR.

As indicated above, 3GPP TS 38.321 [2] describes the Buffer Status reporting (BSR) procedure. For any BSR other than a Pre-emptive BSR, RRC configures the following parameters to control the BSR
periodicBSR-Timer;
retxBSR-Timer;
logicaChannelSR-DelayTimerApplied;
logicalChnnelSR-DelayTimer;
logicalChannelSR-Mask;
logicalChannelGroup.

Each logical channel may be allocated to an LCG using the logicalChannelGroup. The maximum number of LCGs is eight. The MAC entity determines the amount of UL data available for a logical channel according to the data volume calculation procedure.

A BSR other than a Pre-emptive BSR shall be triggered if any of the following events occur:
UL data for a logical channel, which belongs to an LCG, becomes available at the MAC entity and either
   this UL data is associated with a logical channel with higher priority than the priority of any logical channel containing available UL data associated to any existing LCG; or
   none of the logical channels which belong to an LCG contains any available UL data. in which case the BSR is referred below to as a‘Regular BSR’;
UL resources are allocated, and the number of padding bits is equal to or larger than the size of the Buffer Status Report MAC CE plus its subheader, in which case the BSR is referred below to as ‘Padding BSR’;
the retxBSR-Timer expires, and at least one of the logical channels which belong to an LCG contains UL data, in which case the BSR is referred below to as a‘Regular BSR’;
the periodicBSR-Timer expires, in which case the BSR is referred below to as a‘Periodic BSR’.

NOTE 1: When a Regular BSR triggering events occur for multiplelogicalchannels simultaneously, each logical channel triggers one separate Regular BSR.

If configured, a Pre-emptive BSR may be triggered for the specific case of an IAB-MT if any of the following events occur:
a UL grant is provided to a child IAB node or UE;
a BSR is received from a child IAB node or UE.

For a Regular BSR, the MAC entity shall:

| | |
|---|---|
| 1> | if the BSR is triggered for a logical channel for which logicalChannelSR-DelayTimerApplied |

with value true is configured by upper layers:

| | |
|---|---|
| 2> | start or restart the logicalChannelSR-DelayTimer. |
| 1> | else: |
| 2> | if running, stop the logicalChannelSR-DelayTimer. |

For Regular and Periodic BSR, the MAC entity shall:

| | |
|---|---|
| 1> | if more than one LCG has data available for transmission when the |

MAC PDU containing the BSR is to be built:

| | |
|---|---|
| 2> | report Long BSR for all LCGs which have data available for transmission. |
| 1> | else: |
| 2> | report Short BSR. |

For a Padding BSR, the MAC entity shall:

| | |
|---|---|
| 1> | if the number of padding bits is equal to or larger than the size of the Short BSR plus its subheader |

but smaller than the size of the Long BSR plus its subheader:

| | |
|---|---|
| 2> | if more than one LCG has data available for transmission when the BSR is to be built: |
| 3> | if the number of padding bits is equal to the size of the Short BSR plus its subheader: |
| 4> | report a Short Truncated BSR of the LCG with the highest priority logical channel with data |

available for transmission.

| | |
|---|---|
| 3> | else: |
| 4> | report a Long Truncated BSR of the LCG(s) with the logical channels having data available for |

transmission following a decreasing order of the highest priority logical channel (with or without data available
for transmission) in each of these LCG(s), and in case of equal priority, in increasing order of LCGID.

| | |
|---|---|
| 2> | else: |
| 3> | report a Short BSR. |
| 1> | else if the number of padding bits is equal to or larger than the size of the Long BSR plus its subheader: |
| 2> | report a Long BSR for all LCGs which have data available for transmission. |

For a Pre-emptive BSR, the MAC entity shall:

| | |
|---|---|
| 1> | report a Pre-emptive BSR. |

For a BSR triggered by retxBSR-Timer expiry, the MAC entity considers that the logical channel that triggered the BSR is the highest priority logical channel that has data available for transmission at the time the BSR is triggered.

The MAC entity shall:

| | |
|---|---|
| 1> | if the Buffer Status reporting procedure determines that at least one BSR other than a Pre-emptive BSR has |

been triggered and not cancelled:

| | |
|---|---|
| 2> | if UL-SCH resources are available for a new transmission and the UL-SCH resources can accommodate the |

BSR MAC CE plus its subheader as a result of logical channel prioritization:

| | |
|---|---|
| 3> | instruct the Multiplexing and Assembly procedure to generate the BSR MAC CE(s); |
| 3> | start or restart periodicBSR-Timer except when all the generated BSRs are long or short Truncated BSRs; |
| 3> | start or restart retxBSR-Timer. |
| 2> | if a Regular BSR has been triggered and logicalChannelSR-DelayTimer is not running: |
| 3> | if there is no UL-SCH resource available for a new transmission; or |
| 3> | if the MAC entity is configured with configured uplink grant(s) and the Regular BSR was triggered for a |

logical channel for which logicalChannelSR-Mask is set to false; or

| | |
|---|---|
| 3> | if the UL-SCH resources available for a new transmission do not meet the LCP mapping restrictions (see |

clause 5.4.3.1) configured for the logical channel that triggered the BSR:

| | |
|---|---|
| 4> | trigger a Scheduling Request. |
| 1> | if the Buffer Status reporting procedure determines that at least one Pre-emptive BSR has been triggered and |

not cancelled:

| | |
|---|---|
| 2> | if UL-SCH resources are available for a new transmission and the UL-SCH resources can accommodate the |

Pre-emptive BSR MAC CE plus its subheader as a result of logical channel prioritization:

| | |
|---|---|
| 3> | instruct the Multiplexing and Assembly procedure to generate the Pre-emptive BSR MAC CE. |
| 2> | else: |
| 3> | trigger a Scheduling Request. |

NOTE 2: UL-SCH resources are considered available if the MAC entity has an active configuration for either type of configured uplink grants, or if the MAC entity has received a dynamic uplink grant, or if both of these conditions are met. If the MAC entity has determined at a given point in time that UL-SCH resources are available, this need not imply that UL-SCH resources are available for use at that point in time.

For the case when a Pre-emptive BSR is being sent, a MAC PDU may contain one BSR MAC CE for the Pre-emptive BSR, and one BSR MAC CE for a BSR other than the Pre-emptive BSR. A MAC PDU not containing a BSR MAC CE for the Pre-emptive BSR shall contain at most one BSR MAC CE, even when multiple events have triggered a BSR. The Regular BSR and the Periodic BSR shall have precedence over the padding BSR.

The MAC entity shall restart the retxBSR-Timer upon reception of a grant for transmission of new data on any UL-SCH. All triggered BSRs other than the Pre-emptive BSR may be cancelled when the UL grant(s) can accommodate all pending data available for transmission but is not sufficient to additionally accommodate the BSR MAC CE plus its subheader. All BSRs, other than Pre-emptive BSR triggered prior to MAC PDU assembly shall be cancelled when a MAC PDU is transmitted, regardless of LBT failure indication from lower layers, and this PDU includes a Long or Short BSR MAC CE which contains buffer status up to (and including) the last event that triggered a BSR prior to the MAC PDU assembly. A Pre-emptive BSR shall be canceled when a MAC PDU is transmitted and this PDU includes the corresponding Pre-emptive BSR MAC CE.

NOTE 3: MAC PDU assembly can happen at any point in time between uplink grant reception and actual transmission of the corresponding MAC PDU. BSR and SR can be triggered after the assembly of a MAC PDU which contains a BSR MAC CE, but before the transmission of this MAC PDU. In addition, BSR and SR can be triggered during MAC PDU assembly.

NOTE 4: Pre-emptive BSR may be used for the case of dual-connected IAB node. It is up to network implementation to work out the associated MAC entity or entities, and the associated expected amount of data. For the case of dual-connected IAB node, there may be ambiguity in Pre-emptive BSR calculations and interpretation by the receiving nodes in case where BH RLC channels mapped to different egress Cell Groups are not mapped to different ingress LCGs.

NOTE 5: If a HARQ process is configured with cg-RetransmissionTimer and if the BSR is already included in a MAC PDU for transmission by this HARQ process, but not yet transmitted by lower layers, it is up to UE implementation how to handle the BSR content.

MAC PDU

A Medium Access Control (MAC) Protocol Data Unit (PDU) consists of one or more MAC subPDUs. Each MAC subPDU consists of one of the following:
A MAC subheader only (which may include padding);
A MAC subheader and a MAC SDU;
A MAC subheader and a MAC CE;
A MAC subheader and padding.

The MAC SDUs are of variable sizes.

Each MAC subheader corresponds to either a MAC SDU, a MAC CE, or padding.

A MAC subheader except for fixed sized MAC CE, padding, and a MAC SDU containing UL CCCH consists of the four header fields R/F/LCID/L. A MAC subheader for fixed sized MAC CE, padding, and a MAC SDU containing UL CCCH consists of the two header fields R/LCID. FIG. 2A shows an example of a RIF/LCID/L MAC subheader with 8-bit L field. FIG. 2B shows an example of a R/F/LCID/L MAC subheader with 16-bit L field. FIG. 2C shows an example of a R/LCID MAC subheader.

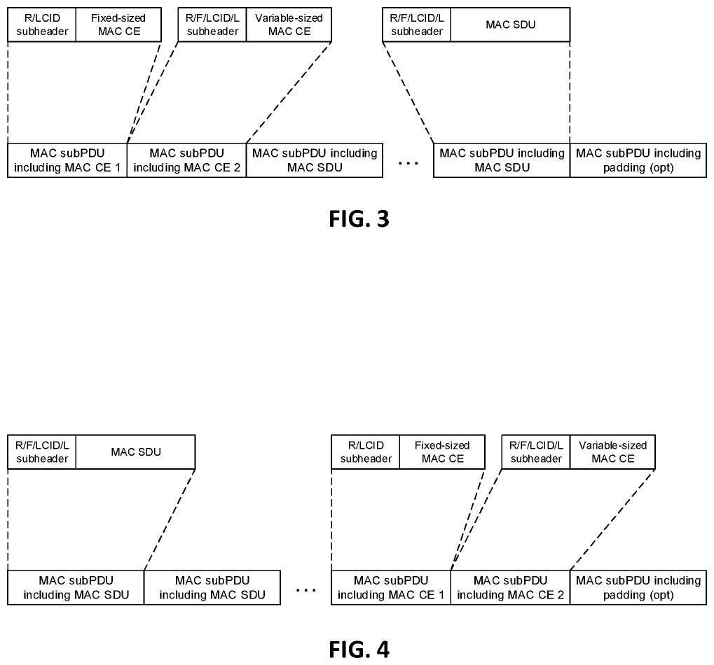

MAC CEs are placed together. DL MAC subPDU(s) with MAC CE(s) is placed before any MAC subPDU with MAC SDU and MAC subPDU with padding as depicted in FIG. 3, which shows an example of a DL MAC PDU. UL MAC subPDU(s) with MAC CE(s) is placed after al the MAC subPDU(s) with MAC SDU and before the MAC subPDU with padding in the MAC PDU as depicted in FIG. 4, which shows an example of an UL MAC PDU. The size of padding can be zero. A maximum of one MAC PDU can be transmitted per TB per MAC entity.

The MAC Subheader

The MAC subheader consists of the following fields:
LCID: The Logical Channel ID field identifies the local channel instance of the corresponding MAC SDU or the type of the corresponding MAC CE or padding as described in Tables 6.2.1-1 and 6.2.1-2 for the DL-SCH and UL-SCH respectively. There is one LCID field per MAC subheader. The LCID field size is 6 bits;
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field
R: Reserved bit, set to 0.

The MAC subheader is octet aligned

TABLE 6.2.1-2 from 38.321[2]: Values of LCID for UL-SCH:

| Index | LCID values |
|---|---|
| 0 | CCCH of size 64 bits (referred to |
| | as “CCCH1” in TS 38.331 [5]) |
| 1-32 | Identity of the logical channel |
| 33-51 | Reserved |
| 52 | CCCH of size 48 bits (referred to |
| | as “CCCH” in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Buffer Status Report MAC CEs

The Buffer Status Report (BSR) MAC CEs consist of either:
Short BSR format (fixed size); or
Long BSR format (variable size); or
Short Truncated BSR format (fixed size);
Long Truncated BSR format (variable size); or
Pre-emptive BSR format (variable size).

The BSR formats are identified by MAC subheaders with LCIDs as exemplified in FIGS. 2 and 3.

The fields in the BSR MAC CE are defined as follows:
LCG ID: The Logical Channel Group ID field identifies the group of logical channel(s) whose buffer status is being reported. The length of the field is 3 bits;
LCG: For the Long BSR format, this field indicates the presence of the Buffer Size field for the logical channel group i. The LCG field set to 1 indicates that the Buffer Size field for the logical channel group i is reported. The LCG field set to 0 indicates that the Buffer Size field for the logical channel group i is not reported. For the Long Truncated BSR format, this field indicates whether logical channel group i has data available. The LCG field set to 1 indicates that logical channel group i has data available. The LCG field set to 0 indicates that logical channel group i does not have data available;
Buffer Size: The Buffer Size field Identifies the total amount of data available according to the data volume calculation procedure in TSs 38.322 [3] and 38.323 [4] across all logical channels of a logical channel group after the MAC PDU has been built (i.e. after the logical channel prioritization procedure, which may result the value of the Buffer Size field to zero). The amount of data is indicated in number of bytes. The size of the RLC and MAC headers are not considered in the buffer size computation. The length of this field for to the Short BSR format and the Short Truncated BSR format is 5 bits. The length of this field for the Long BSR format and the Long Truncated BSR format is 8 bits. The values for the 5 bit and 8-bit Buffer Size fields are shown in Tables 6.1.3.1-1 and 6.1.3.1-2, respectively. For the Long BSR format and the Long Truncated BSR format, the Buffer Size fields are included in ascending order based on the LCG. For the Long Truncated BSR format the number of Buffer Size fields included is maximised, while not exceeding the number of padding bits. For the Pre-emptive BSR, the Buffer Size field identifies the total amount of the data expected to arrive at the IAB-MT of the node where the Pre-emptive BSR is triggered. Pre-emptive BSR is identical to the Long BSR format.

NOTE 1: For the Pre-emptive BSR if configured, the LCGs to be reported, the expected data volume calculation, the exact time to report Pre-emptive BSR and the associated LCH are left to implementation.

NOTE 2: The mapping of LCGs between the ingress and egress links of an IAB node for purposes of determining expected change in occupancy of IAB-MT buffers (to be reported as Pre-emptive BSR) is left to implementation.

NOTE 3: The number of the Buffer Size fields in the Long BSR and Long Truncated BSR format can be zero.

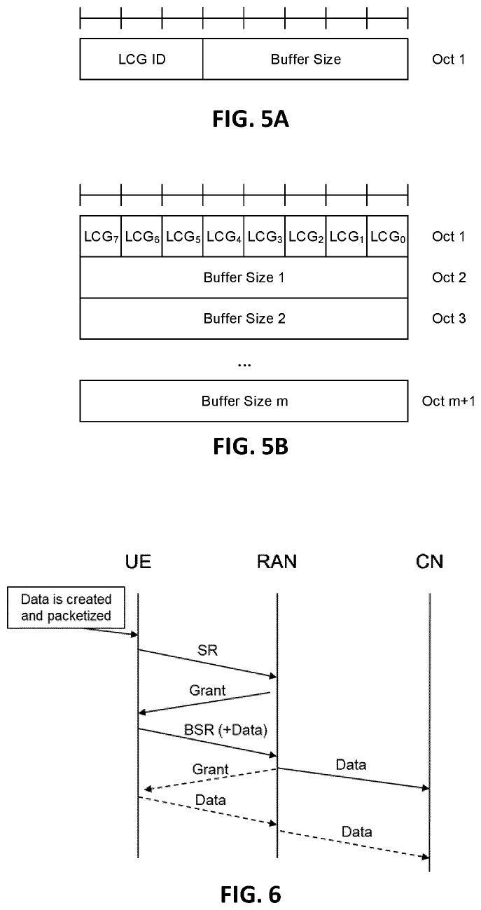

FIG. 5A shown as example of a Short BSR and Short Truncated BSR MAC CE in 3GPP TS 38.321 [2]. FIG. 5B shows an example of Long BSR, Long Truncated BSR, and Pre-emptive BSR MAC CE in 3GPP TS 38.321 [2].

TABLE 6.1.3.1-1
Buffer size levels (in bytes) for 5-bit Buffer Size field in 3GPP
TS 38.321 [2]:

| Index | BS value |
|---|---|
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

TABLE 6.1.3.1-2
Buffer size levels (in bytes) for 8-bit Buffer Size field in 3GPP
TS 38.321 [2]:

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

Pre-Emotive BSR in NR Rel-16

Pre-emptive BSR is introduced in NR Rel-16 for an Integrated Access and Backhaul-Mobile Termination (IAB-MT) to indicate to its parent IAB node that there will be new data received from its child node. As specified in TS 38.321 [2] clause 5.4.5, a pre-emptive BSR can be triggered for an IAB-MT for the below conditions.
A UL grant is provided to child IAB node or UE,
A BSR is received from child IAB node or UE.

For an IAB-MT, the pre-emptive BSR is an optional feature. This feature is activated in case the IAB-MT has received an RRC parameter usePreBSR set as‘True’.

As shown in FIG. 6, which shows an overview of UL transmission delay, the transmission delay for a UL packet, using a dynamic grant, can be estimated considering the below delay components:

UL latency=SR transmission time+SR processing time+grant transmission time+UE processing/encoding time+data transmission time+gNB processing/decoding (1)

With a pre-emptive BSR in an IAB-MT, its parent node can schedule grants to this IAB-MT in advance of new data arriving at this IAB-MT. The latency caused by SR/BSR transmission to its parent node is therefore avoided. In other words, the delay components “SR transmission time+SR processing time+grant transmission time+UE processing time” in the formula (1) can be saved.

Happy Bit

The so-called Happy Bit was used in HSUPA (High-Speed Uplink Packet Access) and can be seen as a very crude way of informing the network of the UEs wish for changes of the current grant (i.e. how the current grant relates to the buffer status). The happy bit was carried in the E-DPCCH (E-DCH Dedicated Control Channel) which also carried other control information such as E-TFCI (E-DCH Transport Format Combination Indicator) and RSN (Retransmission Sequence Number) needed for decoding of the uplink E-DPDCH (Enhanced Dedicated Physical Data Channel). The use of the happy bit is that if it is set to one, it indicates that the UE is happy with the current grant, i.e. that the Grant is large enough to transmit al the data within a certain time frame. If the happy bit is set to zero, the UE is unhappy with the current grant, i.e. that the Grant is NOT large enough to transmit al the data within a certain time frame.

Examples of this disclosure may use the mused “R” field or any other mused field (it may be a unused bit in a field, or an unused range of values in a field) to indicate that this MAC subPDU contains a “BSR lite” in a predefined position. This position can for example be the last bit in the MAC SDU, or the unused numbers/bits in or a new defined LCID table which includes the BSR lite values (see current LCID table above Table 1 Table 6.2.1-2 from 38.321[2] Values of LCID for UL-SCH). The idea is then that the BSR lite bit(s) is accumulated or subtracted towards the previous (normal) BSR report. A first embodiment is when to BSR lie bit indicates a doubling or halving of previous BSR report. A “BSR lite” may comprise for example a BSR or indication of a BSR, where a previous buffer status of a terminal device or UE may be used to convey a current buffer status of the device. That is, for example, an indication may be conveyed that indicates how a previous buffer status can be modified to obtain the current status.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

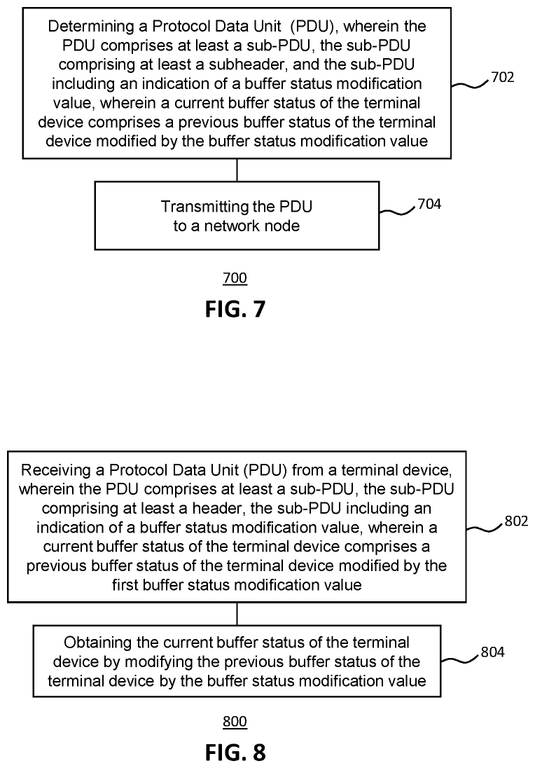

FIG. 7 is a flow chart of an example of a method 700 in a terminal device (e.g. User Equipment, UE). The method 700 comprises, in step 702, determining (e.g. preparing or assembling) a Protocol Data Unit (PDU), e.g. a MAC PDU, wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value. Step 704 of the method 700 comprises transmitting the PDU to a network node.

In some examples, the sub-PDU includes a Medium Access Control (MAC) Service Data Unit (SDU) or MAC Control Element (CE). The MAC SDU may contain user data for example. The MAC SDU or MAC CE may contain the buffer status modification value, for example in a predetermined position.

Alternatively, the subheader may contain the buffer status modification value, for example in a predetermined position (e.g. a currently reserved R field). In such cases, the sub-PDU may contain a MAC SDU, MAC CE, or padding. The buffer status modification value may in some examples be indicated by a predetermined range of values for a LCID field in the subheader.

In some examples, the subheader includes an indication that the sub-PDU includes the indication of the buffer status modification value. This indication that the sub-PDU includes the indication of the buffer status modification value may be included in the header in a predetermined position.

In some examples, the method 700 comprises, before transmitting the PDU to the network node, transmitting the previous buffer status of the terminal device to the network node. Thus for example the buffer status modification value is to modify the previous buffer status that was previously transmitted. Transmitting the previous buffer status of the terminal device to the network node comprises for example transmitting an indication of a previous buffer status modification value to the network node, wherein the previous buffer status of the terminal device comprises an earlier buffer status of the terminal device modified by the buffer status modification value. Thus for example the current status may be determined from multiple modification values as well as an absolute value.

In some examples, the indication of the buffer status modification value comprises an indication of whether to increase or decrease the buffer status modification value.

The indication of the buffer status modification value in some examples comprises at least one of an indication that the current buffer status of the terminal device is the same as the previous buffer status of the terminal device; an indication of an amount by which to modify the previous buffer status of the terminal device; an index to a the amounts by which to modify the previous buffer status of the terminal device; an indication of a percentage by which to modify the previous buffer status of the terminal device; and an indication of whether to double or halve the previous buffer status of the terminal device.

FIG. 8 is a flow chart of an example of a method 80 in a network nod such as for example a base station or gNB. The method 80 comprises, in step 802, receiving a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value. Step 804 of the method 800 comprises obtaining the current buffer status of the terminal device by modifying the previous buffer status of the terminal device by the buffer status modification value. In some examples, the method 800 may be performed by the network node whist the terminal device is performing the method 700 described above.

In some examples, the sub-PDU includes a Medium Access Control (MAC) Service Data Unit (SDU) or MAC Control Element (CE), or padding. The MAC SDU may contain user data. The MAC SDU or MAC CE may contain the buffer status modification value, e.g. in a predetermined position.

Instead, the subheader may contain the buffer status modification value in some examples, e.g. in a predetermined position (in these examples, the sub-PDU in some examples may include a Medium Access Control (MAC) Service Data Unit (SDU) or MAC Control Element (CE), or padding). The buffer status modification value is indicated by a predetermined range of values for a LCID field in the subheader.

In some examples, the subheader includes an indication that the sub-PDU includes the indication of the buffer status modification value, for example in a predetermined position (e.g. a reserved “R” field).

In some examples, the method 800 comprises, before receiving the PDU from the terminal device, receiving the previous buffer status of the terminal device from the terminal device. Receiving the previous buffer status of the terminal device from the terminal device in some examples comprises receiving an indication of a previous buffer status modification value from the terminal device, wherein the previous buffer status of the terminal device comprises an earlier buffer status of the terminal device modified by the buffer status modification value, and modifying the earlier buffer status of the terminal device by the previous buffer status modification value to obtain the previous buffer status of the terminal device. Thus for example the current buffer status may be determined from multiple buffer status modification values as well as an absolute value.

In some examples, the indication of the buffer status modification value comprises an indication of whether to increase or decrease the buffer status modification value.

The indication of the buffer status modification value may in some examples comprise at least one of n indication that the current buffer status of the terminal device is the sane as the previous buffer status of the terminal device; an indication of an amount by which to modify the previous buffer status of the terminal device; an index to a table of amounts by which to modify the previous buffer status of the terminal device; an indication of a percentage by which to modify the previous buffer status of the terminal device; and an indication of whether to double or halve the previous buffer status of the terminal device.

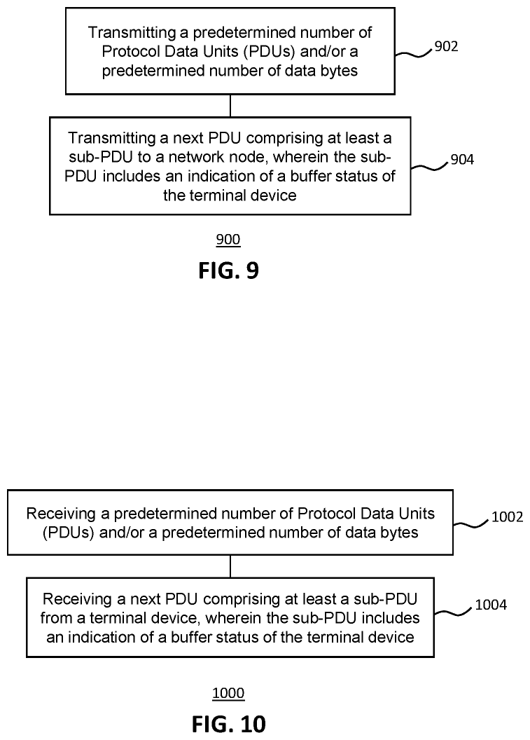

FIG. 9 is a flow chart of an example of a method 900 in a terminal device (e.g. a UE). The method 900 comprises, in step 902, transmitting (e.g. to a network node or base station) a predetermined number of Protocol Data Units (PDUs) and/or a predetermined number of data bytes. Step 904 comprises transmitting a next PDU comprising at least a sub-PDU to a network node, wherein the sub-PDU includes an indication of a buffer status of the terminal device (e.g. an absolute buffer status, or a buffer status modification value). In some examples, the next PDU comprising at least a sub-PDU may be transmitted according to the method 700 described above.

In some examples, the predetermined number of PDUs ad/or the predetermined number of data bytes do not include an indication of the buffer status of the terminal device. That is, for example, the buffer status is transmitted every X bytes and/or every N PDUs, where X and N are predetermined and/or network configured values.

In some examples, the indication of the buffer status of the terminal device comprises a buffer status modification value, wherein a current buffer status of the terminal device comprises a previous buffer status of the terminal device modified by the buffer status modification value. In some examples, the indication of the buffer status of the terminal device is included in every transmitted PDU, or is included in every nth transmitted PDU, wherein n is at least one.

FIG. 10 is a flowchart of an example of a method 1000 in a network node (e.g. base station or gNB). The method 1000 comprises, in step 1002, receiving a predetermined number of Protocol Data Units (PDUs) and/or a predetermined number of data bytes, e.g. from a terminal device or UE. Step 1004 of the method 1000 comprises receiving a next PDU comprising at least a sub-PDU from a terminal device (e.g. the same terminal device or UE), wherein the sub-PDU includes an indication of a buffer status of the terminal device. In some examples, the terminal device performs the method 900 as described above, and/or the next PDU may be received according to the method 80 as described above.

In some embodiments, a “BSR lite” (which is used herein interchangeably with an indication of a buffer status modification value, wherein a current buffer status of a terminal device comprises a previous buffer status of the terminal device modified by the buffer status modification value) is based on a previous BSR report and indicates, for example, that the UE buffer is doubled, and a zero bit indicates the buffer is halved, thus if the BSR lite bit is 1 it means that the UE buffer status (BS) is doubled to form the current buffer status of the terminal device, while if the BSR lite bit is zero the BS is halved t form the current buffer status of the terminal device. In examples disclosed herein, the terms “terminal device” and “User Equipment” (UE) may be used interchangeably, thou the terminal device may be another type of node. Similarly, the terms “network node” “gNB” and “base station” may be used interchangeably, though the network node may be another type of node.

In some examples, the BSR lite indicates a change which is a relative fraction of the previously reported value, e.g. previous buffer status shod be increased or decreased by a predetermined percentage, or by a percentage that is indicated in the BSR lite.

The BSR lite may in some examples be indicated in the MAC PDU for user data (MAC SDU), using the unused “R” position of the MAC PDU header as shown in FIGS. 2A-C. Thus, if the “R” field is one for example, this indicates that this MAC PDU (or sub-PDU) contains a BSR lite. The position of the BSR lie may be predefined, for example in the last position in the sub-header or last position in the MAC SDU. A new LCID may be defined to identify the BSR lie (i.e. convey the information for the BSR lite). A new LCID table can take advantage of the fact that there are unused numbers in the current LCID table, which means it is possible to add BSR lite information, such as for example a buffer status modification value.

In some examples, the BSR lie consists of two or more bits and can therefore indicate higher granularity of change versus a single bit BSR lite, but it is still relative to the previous BSR BS—that is, the BSR lie still conveys a buffer status modification value, for example.

In some examples, the BSR lite may be configured to the UE via signaling means such as system information, RRC signaling, MAC CE or DCI.

In some examples, a default BSR lie configuration may be configured to the UE (e.g. by a network node or base station). In this way the UE would in some examples apply a default fraction of change relative to the previously sent BSR for a logical channel (LCH) or logical channel group (LCG) in case there is no mapping relation or rule configured yet when the UE has data available for that LCH or LCG.

In some examples, how to choose which BSR lie configuration to be used by a UE may be determined based on UE capability. UE capability is a list of what the UE is capable of, such as maximum bitrate, supported frequency bands, TDD/FDD, support of protocol features, etc., used by the gNB to correctly configure the communication sessions. In this case, it may be the set of available tables for a specific UE capacity and the specific mapping for a UE capability.

In some examples, the UE reports BSR Ike in every MAC PDU for the data without any indication needed in the sub-header.

In some examples, the BSR lite is encoded in the L field. In this case, some of the possible legacy lengths may be reserved for the BSR lite bits.

In some examples, if there is no normal BSR report within a predetermined time (e.g. T ms), the (first) BSR lie then means that the BS of the associated LCHs or LCG is a predetermined amount (e.g. X bytes), where these predetermined values (e.g. T and X) may in some examples be configured values by RRC signaling.

In some examples, the UE identifies “short data”, i.e., data that is sent in one TTI, that occurs with some periodicity and sets a flag in the sub-header for the MAC PDU for the data (MAC SDU), that corresponds to a BSR saying “same as last TTI”. Thus, a sensor that occasionally sends periodical data can be configured for dynamic scheduling and at the same time be able to switch to some sort of semi-persistent scheduling.

In some examples, the BSR lite indicates a value based on the previously reported BSR (i.e. short or long BSR) reduced by the aggregated grants received since the previous BSR was reported. If for example the UE reports a BSR of X bytes and receives a grant of Y bytes, the BSR lite would report a value (increase/decrease/same) relative to X-Y. If yet another grant of Z bytes is received, the BSR lite would report relative to X-Y-Z. The received grants may be dynamic grants and/or configured grants.

In some examples, a BSR lite can be generated indicating the request similar to the resource allocation it received in (a) last TTI, (b) the last allocation which may or may not happen in the last TTI (pointer to specific allocation), (c) the allocation or grant corresponding to UL (PUSCH) or DL (PDSCH), e.g., it means the UE sends a BSR lite to demand resources for a UL transmission similar to the PDSCH allocation. Further, the UE can also generate an SR (rather BSR) that asks the gNB to allocate the same resources it did in the last TTI or in the last allocation for its previous request (just like (a)-(c)). This can be accomplished by configuring a separate PUCCH resource for this SR or by introducing a multi-bit SR where one of the bits indicate one of (a)-(c).

Some examples may provide new BSR triggering conditions for any BSR type (e.g., short BSR, long BSR, Short Truncated BSR, Long Truncated BSR, and preemptive BSR). In some examples, the gNB configures a rule to allow the UE to report BSR based on how much data that the UE has transmitted, e.g., report BSR per X Bytes, or per X PDUs.

As an example, a BSR may be triggered per every MAC PDU. In other words, the UE will always include a BSR in every transmitted MAC PDU.

As a second example, a BSR may be triggered per every X MAC PDUs, where X can be configured by the gNB.

As a third example, a BSR may be triggered every X Bytes of transmitted MAC SDUs (e.g. containing user data), where X can be configured by the gNB. X may in some examples refer to the number of bytes delivered to the MAC by upper layer.

In some examples, any BSR can be truncated in case there are not enough bits to carry the BSR MAC CE. In this case, the UE includes buffer size (BS) of LCHs/LCGs in the MAC CE following a decreasing order of the priority indices of LCHs/LCGs.

In some examples, the BSR lite has higher than or equal to priority of a regular BSR. Regardless of the grant size, a BSR lite may in some examples be always be triggered for every MAC PDU. If the grant size is too small, the MAC PDU may only carry a BSR lite. BSR lite can be configured for one or multiple specific LCH or LCG. In case a UE is configured with multiple LCHs or LCGs, there may be some LCHs or LCGs configured with BSR lite, while other LCHs or LCGs are not configured with BSR lie.

In some examples, certain CG resources are configured specifically for the BSR report. The CG resources should be tight in time (low delay) and small, e.g. the resources could be sufficient to transmit only a single BSR MAC CE. In one example, a BSR lite is transmitted in every CG occasion, in this case, an SR trigger for requesting resources for BSR may be avoided. As an example, CG resources could be pre-configured PUSCH resources used to transmit the payload for a 2-step RA.

In some examples, a UE can be configured with a small or reduced table in which it has the most often recurring buffer sizes, then BSR lite can indicate only those indices in the table. For example, if a UE has mostly requested two types of sizes, then 1 bit is enough, and another bit for LCG/LCH priority (e.g., indicating low or high priority), and in this example, perhaps a minimum of 2 bits are needed to report BSR status. This information can be carried in the BSR lite according to the previous embodiments.

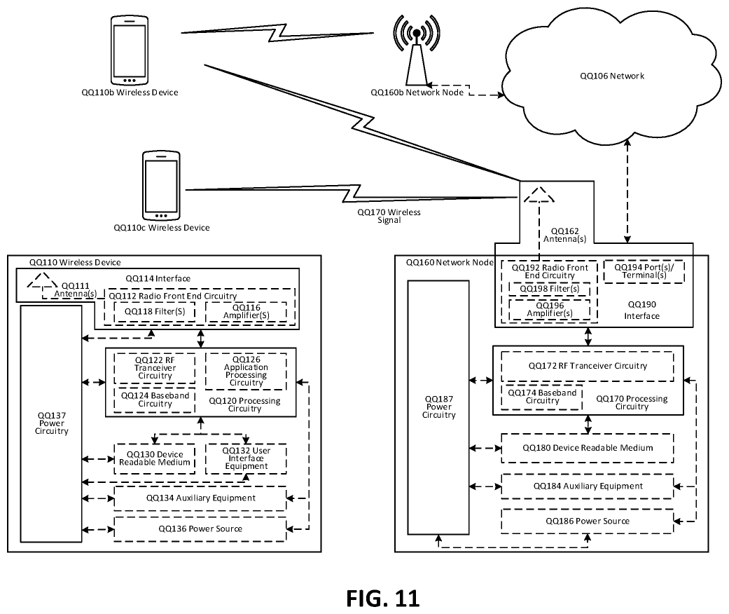

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (MAN) standards, such as the IEEE 802.11 standards; and/or any other appropriate wireless communication standard, such as the Worldwide Interoperability for Microwave Access (WiMax), Bluebooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or al) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node QQ160 includes processing circuitry QQ170, device readable medium QQ180, interface QQ190, auxillary equipment QQ184, power source QQ186, power circuitry QQ187, and antenna QQ162. Although network node QQ160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or al of the functionality may be provided by processing circuitry QQ170 without executing instructions stored on a separate or discrete device readable medium, such as in a hard-wed manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, sold-state memory, remotely mounted memory, magnetic media, optical media, random access memory (RAM), read-only memory (ROM), mass storage media (for example, a hard disk), removable storage media (for example, a flash dive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Redo front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, al or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power soiree QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 11 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-t-vehicle (V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or al of RF transceiver circuitry QQ122 may be considered a part of interface QQ114. Radio front end circuitry QQ112 may receive digital date that is to be sent out to other network nodes or WDs via a wireless connection. Radio front end circuitry QQ112 may convert the digital data into a radio signal having the appropriate channel and bandwidth parameters using a combination of titers QQ118 and/or amplifiers QQ116. The radio signal may then be transmitted via antenna QQ111. Similarly, when receiving data, antenna QQ111 may collect radio signals which are then converted into digital date by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or al of baseband processing circuitry QQ124 and application processing circuitry QQ126 may be combined into one chip or set of chips, and RF transceiver circuitry QQ122 may be on a separate chip or set of chips. In still alternative embodiments, part or al of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be apart of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or al of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device read e medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, date, and/or instructions that may be used by processing circuitry QQ120. In some embodiments, processing circuitry QQ120 and device readable medium QQ130 may be considered to be integrated User interface equipment QQ132 may provide components that allow for a human user to interact with WD QQ110.

Such interaction may be of many forms, such as visual, audial, tactile, etc. User interface equipment QQ132 may be operable to produce out to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

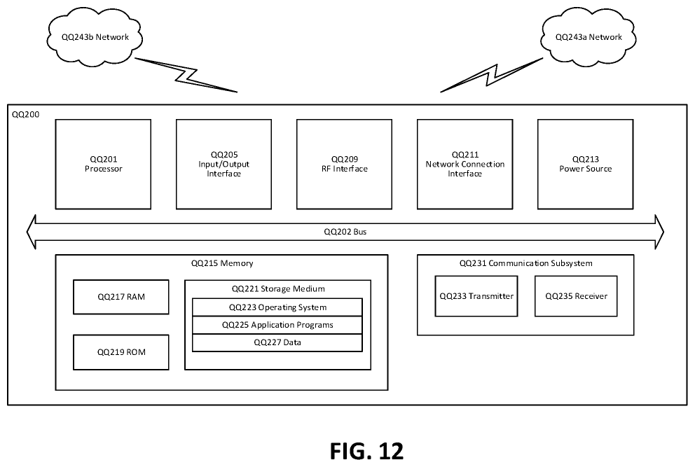

FIG. 12 illustrates one embodiment of a UE (or terminal device) in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ200 may be any UE identified by the 3 Generation Partnership Project (3GPP), including a NB-IoT UE, a machine type communication (MTC) UE, and/or an enhanced MTC (eMTC) UE. UE QQ200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the Ike, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize al of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry QQ201 may be configured to process computer instructions and data Processing circuitry QQ201 may be configured to implement any sequential state machine operative to execute machine instructions stored as machine-readable computer programs n the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another out device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitives display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another Ike network or any combination thereof. For example, network QQ243a may comprise a VW-Fi network. Network connection interface QQ211 may be configured to include a receiver and a transmitter interface used to communicate with one or more other devices over a communication network according to one or more communication protocols, such as Ethernet, TCP/IP, SONET, ATM, or the Ike. Network connection interface QQ211 may implement receiver and transmitter functionality appropriate to the communication network links (e.g., optical, electrical, and the like). The transmitter and receiver functions may share circuit components, software or firmware, or amatively may be implemented separately.

RAM QQ217 may be configured to interface via bus QQ202 to processing circuitry QQ201 to provide storage or caching of data or computer instructions during the execution of software programs such as the operating system, application programs, and device divers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical dive units, such as redundant array of independent disks (RAID), floppy disk dive, flash memory, USB flash dive, external hard disk dive, thumb dive, pen dive, key drive, high-density digital versatile disc (HD-DVD) optical disc dive, internal hard disk drive, Blu-Ray optical disc dive, holographic digital data storage (HDDS) optical disc dive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the Ike, stored on transitory or non-transitory memory media, to off-load data, or to upload data. An article of manufacture, such as one utilizing a communication system may be tangibly embodied in storage medium QQ221, which may comprise a device readable medium.

In FIG. 12, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the Ike. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment the communication functions of communication subsystem QQ231 may include data communication, voice communication, multimedia communication, short-range communications such as Bluetooth, near-field communication, location based communication such as the use of the global positioning system (GPS) to determine allocation, another like communication function, or any combination thereof. For example, communication subsystem QQ231 may include cellular communication, Wi-Fi communication, Bluetooth communication, and GPS communication. Network QQ243b may encompass wed ad/or wireless networks such as a local-area network (LAN), a wide-area network (WAN), a computer network, a wireless network, a telecommunications network, another like network or any combination thereof. For example, network QQ243b may be a cellular network, a Wi-F network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In mother example, any of such components may be represented by program instructions stored in memory that when executed by processing circuitry QQ201 perform the corresponding functions described herein. In another example, the functionality of any of such components may be partitioned between processing circuity QQ201 and communication subsystem QQ231. In another example, the non-computationally intensive functions to any of such components may be implemented in software or firmware and the computationally intensive functions may be implemented in hardware.

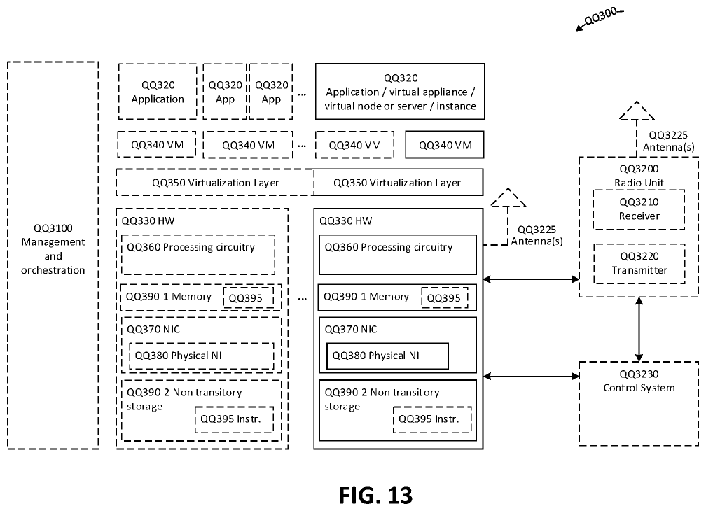

FIG. 13 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all the functions described herein may be implemented as virtual components executed by one or more virtual machines implemented in one or more virtual environments QQ300 hosted by one or more of hardware nodes QQ330. Further, in embodiments in which the virtual node is not a radio access node or does not required radio connectivity (e.g., a core network node), then the network node may be entirely virtualized.

The functions may be implemented by one or more applications QQ320 (which may alternatively be allied software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears Ike networking hardware to virtual machine QQ340.

As shown in FIG. 13, hardware QQ330 may be a standalone network node with generic or specific components. Hardware QQ330 may comprise antenna QQ3225 and may implement some functions via virtualization. Alternatively, hardware QQ330 may be pat of a larger duster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handing specific network functions that run in one or more virtual machines QQ340 on top of hardware networking infrastructure QQ330 and corresponds to application QQ320 in FIG. 13.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in continuation with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

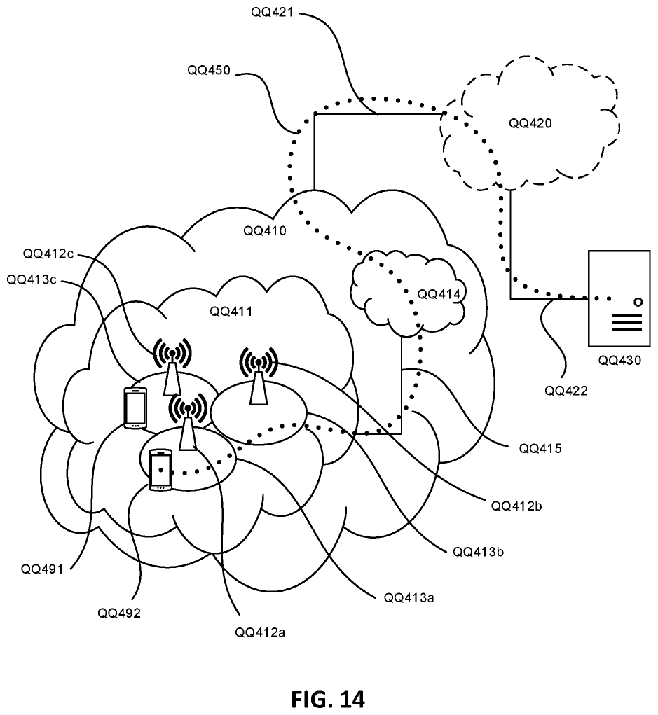

With reference to FIG. 14, in accordance with an embodiment, a communication system includes telecommunication network QQ410, such as a 3GPP-type cellular network, which comprises access network QQ411, such as a radio access network, and core network QQ414. Access network 411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a pubic, private or hosted network; intermediate network QQ420, if any, may be a backbone network or the Internet; in particular, intermediate network QQ420 may comprise two or more sub-networks (not shown).

The communication system of FIG. 14 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of plink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

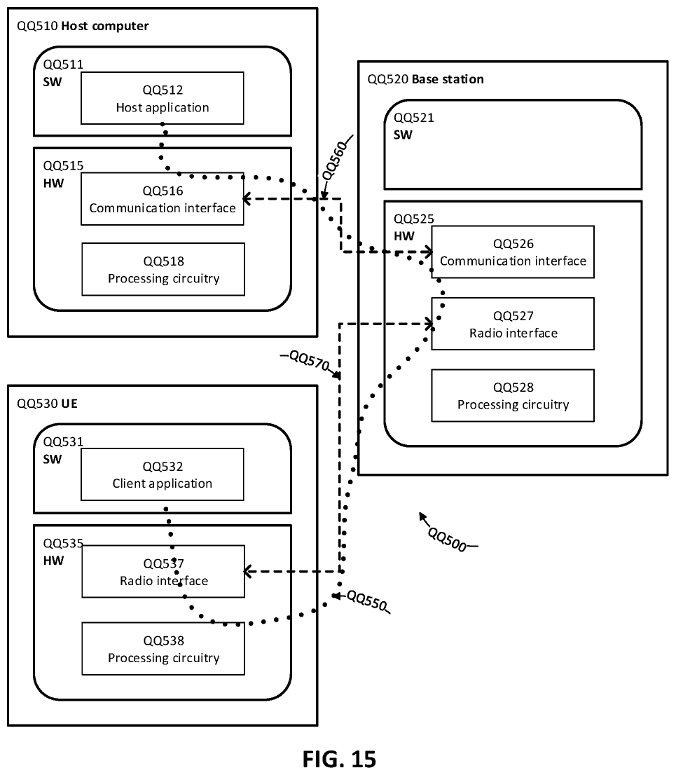

Example implementations, in accordance with an embodiment, of the UE, base station and host computer discussed in the preceding paragraphs will now be described with reference to FIG. 15. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 15) served by base station QQ520. Communication interface QQ526 may be configured to facilitate connection QQ560 to host computer QQ510. Connection QQ560 may be direct or it may pass through a core network (not shown in FIG. 15) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set p and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to genera the user data that it provides.

It is noted that host computer QQ510, base station QQ520 and UE QQ530 illustrated in FIG. 15 may be similar or identical to host computer QQ430, one of base stations QQ412a, QQ412b, QQ412c and one of UEs QQ491, QQ492 of FIG. 14, respectively. This is to say, the inner workings of these entities may be as shown in FIG. 15 and independently, the surrounding network topology may be that of FIG. 14.

In FIG. 15, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art In certain embodiments, measurements may involve proprietary UE signaling facilitating host computer QQ510's measurements of throughput, propagation times, latency and the Ike. The measurements may be implemented in that software QQ511 and QQ531 causes messages to be transmitted, in particular empty or ‘dummy’ messages, using OTT connection QQ550 we it monitors propagation times, errors etc.

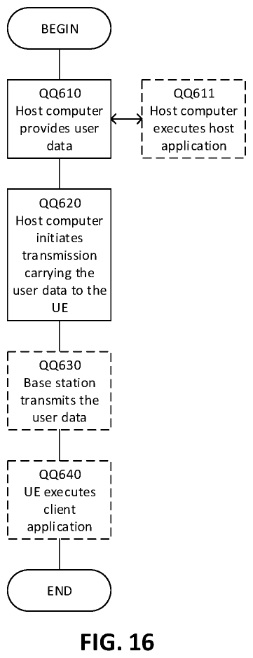

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step QQ610, the host computer provides user data In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

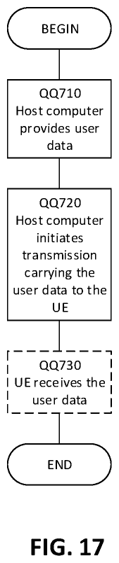

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step QQ710 of the method, the host computer provides user data. In an optional substep (not shown) the host compuler provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

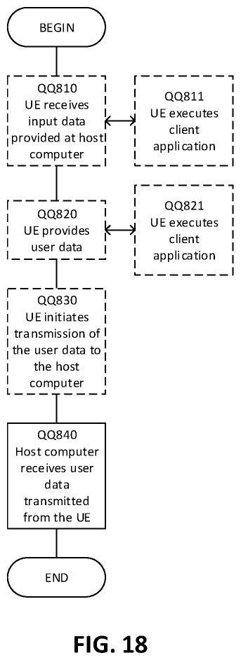

FIG. 18 is a flowchart illustrating a method implemented in a communication system, in accordance with one embodiment. The communication system includes a host compuler, a base station and a UE which may be those described with reference to FIGS. 14 and 15. For simplicity of the present disclosure, only drawing references to FIG. 18 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host compuler. In step QQ840 of the method, the host computer receives the user data transmitted from the UE, in accordance with the teachings of the embodiments described throughout this disclosure.

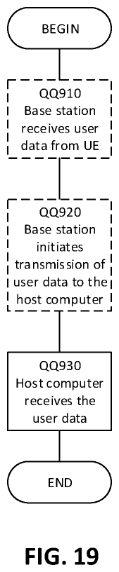

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

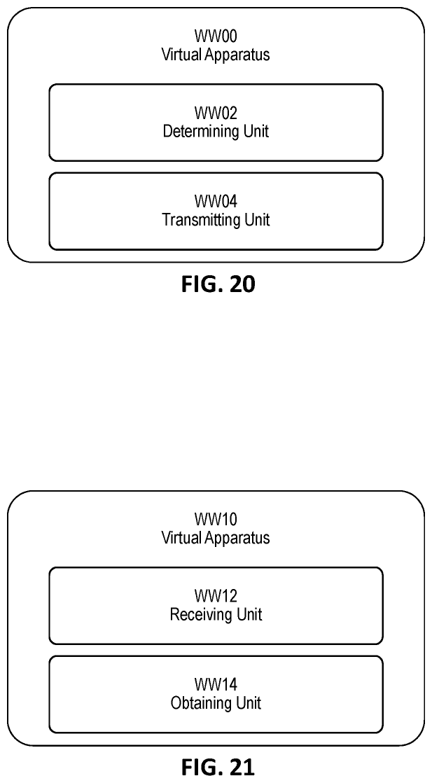

FIG. 20 illustrates a schematic block diagram of an apparatus WW) in a wireless network (for example, the wireless network shown in FIG. 11). The apparatus may be implemented in a wireless device or network node (e.g., wireless device QQ110 or network node QQ160 shown in FIG. 11). Apparatus WW00 is operable to carry out the example method described with reference to FIG. 700 and possibly any other processes or methods disclosed herein. It is also to be understood that the method of FIG. 700 is not necessarily carried out solely by apparatus WW00. At least some operations of the method can be performed by one or more other entities.

Virtual Apparatus WW00 may comprise processing circuitry, which may include one or more microprocessor or microcontrollers, as well as other digital hardware, which may include digital signal processors (DSPs), special-purpose digital logic, and the Ike. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Determining Unit WW02, Transmitting Unit WW04, and any other suitable units of apparatus WW00 to perform corresponding functions according one or more endowments of the present disclosure.

As illustrated in FIG. 20, apparatus WW00 includes Determining Unit WW2 configured to determine a Protocol Data Unit (PDU), wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value, and Transmitting Unit WW4 configured to transmit the PDU to a network node.

FIG. 21 illustrates a schematic block diagram of an apparatus WW10 in a wireless network (for example, the wireless network shown in FIG. 11). The apparatus may be implemented in a wireless device or network node (e.g., wireless device QQ110 or network node QQ160 shown in FIG. 11). Apparatus WW10 is operable to carry out the example method described with reference to FIG. 800 and possibly any other processes or methods disclosed herein. It is also to be understood that the method of FIG. 800 is not necessarily carried out solely by apparatus WW10. At least some operations of the method can be performed by one or more other entities.

Virtual Apparatus WW10 may comprise processing circuitry, which may include one or more microprocessor or microcontrollers, as well as other digital hardware, which may include digital signal processors (DSPs), special-purpose digital logic, and the Ike. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Receiving Unit WW12, Obtaining Unit WW14, and any other suitable units of apparatus WW10 to perform corresponding functions according one or more embodiments of the present disclosure.

As illustrated in FIG. 21, apparatus WW10 includes Receiving Unit WW12 configured to receive a Protocol Data Unit (PDU) from a terminal device, wherein the PDU comprises at least a sub-PDU, the sub-PDU comprising at least a header, the sub-PDU including an indication of a buffer status modification value, wherein a current buffer status of the terminal device comprises a previous buffer status of the terminal device modified by the first buffer status modification value, and Obtaining Unit WW14 configured to obtain the current buffer status of the terminal device by modifying the previous buffer status of the terminal device by the buffer status modification value.

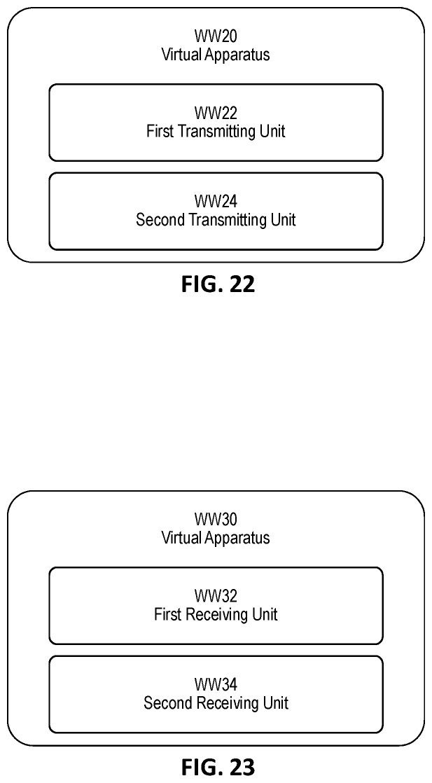

FIG. 22 illustrates a schematic block diagram of an apparatus WW20 in a wireless network (for example, the wireless network shown in FIG. 11). The apparatus may be implemented in a wireless device or network node (e.g., wireless device QQ110 or network node QQ160 shown in FIG. 11). Apparatus WW20 is operable to carry out the example method described with reference to FIG. 900 and possibly any other processes or methods disclosed herein. It is also to be understood that the method of FIG. 900 is not necessarily carried out solely by apparatus WW20. At least some operations of the method can be performed by one or more other entities.

Virtual Apparatus WW20 may comprise processing circuitry, which may include one or more microprocessor or microcontrollers, as well as other digital hardware, which may include digital signal processors (DSPs), special-purpose digital logic, and the Ike. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause First Transmitting Unit WW22, Second Transmitting Unit WW24, and any other suitable units of apparatus WW20 to perform corresponding functions according one or more embodiments of the present disclosure.

As illustrated in FIG. 22, apparatus WW20 includes First Transmitting Unit WW22 configured to transmit a predetermined number of Protocol Data Units (PDUs) and/or a predetermined number of data bytes, and Second Transmitting Unit WW24 configured to transmit a next PDU comprising at least a sub-PDU to a network node, wherein the sub-PDU includes an indication of a buffer status of the terminal device.

FIG. 23 illustrates a schematic block diagram of an apparatus WW30 in a wireless network (for example, the wireless network shown in FIG. 11). The apparatus may be implemented in a wireless device or network node (e.g., wireless device QQ110 or network node QQ160 shown in FIG. 11). Apparatus WW3) is operable to carry out the example method described with reference to FIG. 1000 and possibly any other processes or methods disclosed herein. It is also to be understood that the method of FIG. 1000 is not necessarily carried out solely by apparatus WW30. At least some operations of the method can be performed by one or more other entities.

Virtual Apparatus WW30 may comprise processing circuitry, which may include one or more microprocessor or microcontrollers, as well as other digital hardware, which may include digital signal processors (DSPs), special-purpose digital logic, and the Ike. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause First Receiving Unit WW32, Second Receiving Unit WW34, and any other suitable units of apparatus WW3) to perform corresponding functions according one or more embodiments of the present disclosure.

As illustrated in FIG. 23, apparatus WW30 includes First Receiving Unit WW32 configured to receive a predetermined number of Protocol Data Units (PDUs) and/or a predetermined number of data bytes, and Second Receiving Unit WW34 configured to receive a next PDU comprising at least a sub-PDU from a terminal device, wherein the sub-PDU includes an indication of a buffer status of the terminal device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### REFERENCES

The following references are incorporated herein by reference.
1. RP-193259, “3GPP Work Item Description: Study on supporting NR from 52.6 GHz to 71 GHz”, Intel Corporation, 3GPP TSG RAN Meeting #86, Dec. 9-12, 2019
2. 3GPP TS 38.321, V 16.0.0
3. 3GPP TS 38.322, V 16.0.0
4. 3GPP TS 38.323, V 16.0.0
5. 3GPP TS 38.331, V 16.0.0

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA20001× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per dip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format indicator Channel
PDCCH Physical Downlink Control Channel
PDP Profile Delay Profile
PDSCH Physical Downlink Shared Channel
PGW Packet Gateway
PHICH Physical Hybrid-ARQ indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
Scell Secondary Cell
SDU Service Data Unit
SFN System Frame Number
SGW Serving Gateway
SI System Information
SIB System Information Block
SNR Signal to Noise Ratio
SON Set Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1.-65. (canceled)

66. A method in a terminal device, the method comprising:
determining a Protocol Data Unit (PDU), wherein the PDU comprises at least a sub-PDU, the sub-PDU comprising at least a subheader, and the sub-PDU including an indication of a buffer status modification value, wherein a current buffer status of the terminal device comprises a previous buffer status of the terminal device modified by the buffer status modification value; and
transmitting the PDU to a network node.

67. The method of claim 66, wherein the sub-PDU includes a Medium Access Control (MAC) Service Data Unit (SDU) or MAC Control Element (CE).

68. The method of claim 67, wherein the MAC SDU or MAC CE contains the buffer status modification value.

69. The method of claim 66, wherein the subheader contains the buffer status modification value.

70. The method of claim 66, wherein the buffer status modification value is indicated by a predetermined range of values for a LCID field in the subheader.

71. The method of claim 66, wherein the sub-PDU comprises padding, or comprises only the subheader.

72. The method of claim 66, wherein the subheader includes an indication that the sub-PDU includes the indication of the buffer status modification value.

73. The method of claim 72, wherein the indication that the sub-PDU includes the indication of the buffer status modification value is included in the header in a predetermined position.

74. The method of claim 66, comprising, before transmitting the PDU to the network node, transmitting the previous buffer status of the terminal device to the network node.

75. The method of claim 74, wherein transmitting the previous buffer status of the terminal device to the network node comprises transmitting an indication of a previous buffer status modification value to the network node, wherein the previous buffer status of the terminal device comprises an earlier buffer status of the terminal device modified by the buffer status modification value.

76. The method of claim 66, wherein the indication of the buffer status modification value comprises at least one of:
an indication of whether to increase or decrease the buffer status modification value;
an indication that the current buffer status of the terminal device is the same as the previous buffer status of the terminal device;
an indication of an amount by which to modify the previous buffer status of the terminal device;
an index to a table of amounts by which to modify the previous buffer status of the terminal device;
an indication of a percentage by which to modify the previous buffer status of the terminal device; and
an indication of whether to double or halve the previous buffer status of the terminal device.

77. The method of claim 66, wherein the PDU comprises a Medium Access Control (MAC) PDU.

78. The method of claim 66, wherein the network node comprises a base station.

79. A method in a terminal device, the method comprising:
transmitting a predetermined number of Protocol Data Units (PDUs) and/or a predetermined number of data bytes; and
transmitting a next PDU comprising at least a sub-PDU to a network node,
wherein the sub-PDU includes an indication of a buffer status of the terminal device,

80. The method of claim 79, wherein the predetermined number of PDUs and/or the predetermined number of data bytes do not include an indication of the buffer status of the terminal device.

81. The method of claim 79, wherein the indication of the buffer status of the terminal device comprises a buffer status modification value, wherein a current buffer status of the terminal device comprises a previous buffer status of the terminal device modified by the buffer status modification value.

82. The method of claim 79, wherein the indication of the buffer status of the terminal device is included in every transmitted PDU.

83. The method of claim 79, wherein the indication of the buffer status of the terminal device is included in every nth transmitted PDU, wherein n is at least one.

84. The method of claim 79, wherein the predetermined number of PDUs and/or the predetermined number of data bytes is configured by the network node.

85. Apparatus in a terminal device, the apparatus comprising a processor and a memory, the memory containing instructions executable by the processor such that the apparatus is operable to claim 66.
